(19) United States
(12) Patent Application Publication
(10) Pub. No.: US 2014/0209018 A1
(43) Pub. Date: Jul. 31, 2014

(54) METHOD, SYSTEM, AND STRUCTURE OF STATOR WITH COMMON INSULATING AND VARNISHING RESIN

(71) Applicant: GM GLOBAL TECHNOLOGY OPERATIONS LLC, Detroit, MI (US)

(72) Inventors: Xiaoling Jin, Farmington Hills, MI (US); Micah Joel Fuchs, Detroit, MI (US); John D. Campbell, Rochester Hills, MI (US); Edward L. Kaiser, Orion, MI (US)

(73) Assignee: GM GLOBAL TECHNOLOGY OPERATIONS LLC, Detroit, MI (US)

(21) Appl. No.: 13/750,438

(22) Filed: Jan. 25, 2013

(51) Int. Cl. H02K 15/02; H02K 3/30

(52) U.S. Cl. CPC H02K 15/02; H02K 3/30
USPC 118/58; 427/104; 310/203

(57) ABSTRACT

A stator having a common varnish and weld insulation includes a stator lamination core and a motor winding wound around the stator lamination core. The motor winding includes a plurality of magnet wires configured such that they are substantially parallel to each other. Each magnet wire has two distal ends configured such that each distal end is welded to one distal end of an adjacent magnet wire, thereby forming a plurality of welded tips. The stator further includes a resin coating the welded tips and the stator. The resin serves as both a primary insulation for the welded tips, and as a varnish for the stator. This dual function of the resin may eliminate the need for separate insulation for the welded tips and varnish for the stator, and allow the resin to be applied to the welded tips and to the stator at substantially the same time.

### TECHNICAL FIELD

The present invention relates to a stator, such as a bar-wound stator, with a common insulating and varnishing resin, as well as a system and method for applying the resin.

### BACKGROUND

Electric vehicles, including hybrid vehicles, employ electric motors, such as induction motors and permanent magnet motors, to propel the vehicles, as well as to capture braking energy when acting as an electric generator. An electric motor converts electrical energy into mechanical energy through the interaction of magnetic fields and current-carrying conductors to generate force. The electric motor generally includes a rotor, which transmits torque through a gear set to the drive wheels of the vehicle, and a stator, which contain the conductors in the form of motor windings, which are typically constructed from magnet wire. The stator may be wire-wound, where the motor windings are generally pre-formed wire bundles, or bar-wound, where each magnet wire is a solid piece of wire bent into a defined shape.

The magnet wires are generally copper or aluminum wires coated with a layer of insulation. In a bar-wound stator, the insulation at the tip of each magnet wire is stripped off, exposing the copper or aluminum wire so that adjacent magnet wires may be welded together at the exposed tip. As such, the resultant welded tips need to be reinsulated. In addition, the stator assembly needs to be varnished for structural stability. One way this is accomplished is by first applying an epoxy powder coating to the welded tips as the primary insulation, and then subsequently applying a separate varnish to the stator assembly.

### SUMMARY

A stator having a common varnish and weld insulation system is provided. The stator includes a stator lamination core and a motor winding around the stator lamination core. The motor winding includes a plurality of magnet wires that are configured such that they are substantially parallel to each other. Each magnet wire has two distal ends that are configured such that each distal end is welded to one distal end of an adjacent magnet wire, thereby forming a plurality of welded tips. The stator further includes a first layer of a resin coating the stator, including the welded tips, and a second layer of the resin coating just the welded tips. The second layer may cover the first layer, or the first layer may cover the second layer, depending on the order in which they are applied. The resin serves as both a primary insulation for the welded tips, and as a varnish for the stator. This dual function of the resin may eliminate the need for separate insulation for the welded tips and varnish for the stator.

A method of varnishing a stator and insulating welded tips of the stator is also provided. As described above, the stator has a stator lamination core, a motor winding including a plurality of magnet wires, and a plurality of welded tips formed from adjacent magnet wires welded together. The method includes first applying a first layer of a resin to the stator via a first application process. The method then includes applying a second layer of the resin to the welded tips via a second application process, such that the second layer covers the first layer at the welded tips. The second application process may occur prior to the first application process such that the first layer covers the second layer at the welded tips. As explained above, the resin serves as both a primary insulation for the welded tips, and as a varnish for the stator. The dual function of the resin may further allow the first application process and the second application process to occur at substantially the same time.

The first application process may be a trickling process in which the resin is trickled over the stator such that the resin flows through any nooks or crevices, thereby ensuring that the stator lamination core and the magnet wires are completely coated in the resin. The resin may be heated to make it less viscous for the trickling process.

The second application process may be a dipping process in which the welded tips are first dipped into a pool of the resin such that the welded tips are coated in the resin. The welded tips are then removed from the pool of the resin.

The method may also include baking the stator to cure and dry the first layer and the second layer of the resin. The method may further include preheating the stator lamination core prior to at least one of the first application process and the second application process.

A system for varnishing a stator and insulating welded tips of the stator is also provided. The system may be utilized in the method described above. The system includes a trickling device to trickle a resin over the stator, including the welded tips, to form a first layer of the resin. The system also includes a pool of the resin in which the welded tips are dipped to form a second layer of the resin. As explained above, the second layer may cover the first layer at the welded tips, or the first layer may cover the second layer at the welded tips, depending on the order in which they are applied. The system further includes a first heating source to bake the stator to cure and dry the first layer and the second layer. Again, the resin serves as both a primary insulation for the welded tips, and as a varnish for the stator.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, front view of a stator having a stator lamination core and a motor winding with a plurality of magnet wires;

FIG. 2 is a schematic, front view of a magnet wire of the stator of FIG. 1;

FIG. 3 is a schematic, fragmentary enlarged view of the stator, particularly the motor winding, of FIG. 1;

FIG. 4 is a schematic block diagram of an exemplary system for insulating and varnishing the stator of FIG. 1; and

FIGS. 5, 5A, and 5B are schematic flow diagrams illustrating an exemplary method of insulating and varnishing the stator of FIG. 1.

### DETAILED DESCRIPTION

Those having ordinary skill in the art will recognize that terms such as “above,” “below,” “upward,” “downward,” et cetera, are used descriptively of the figures, and do not represent limitations on the scope of the invention, as defined by the appended claims. Any numerical designations, such as “first” or “second” are illustrative only and are not intended to limit the scope of the invention in any way.

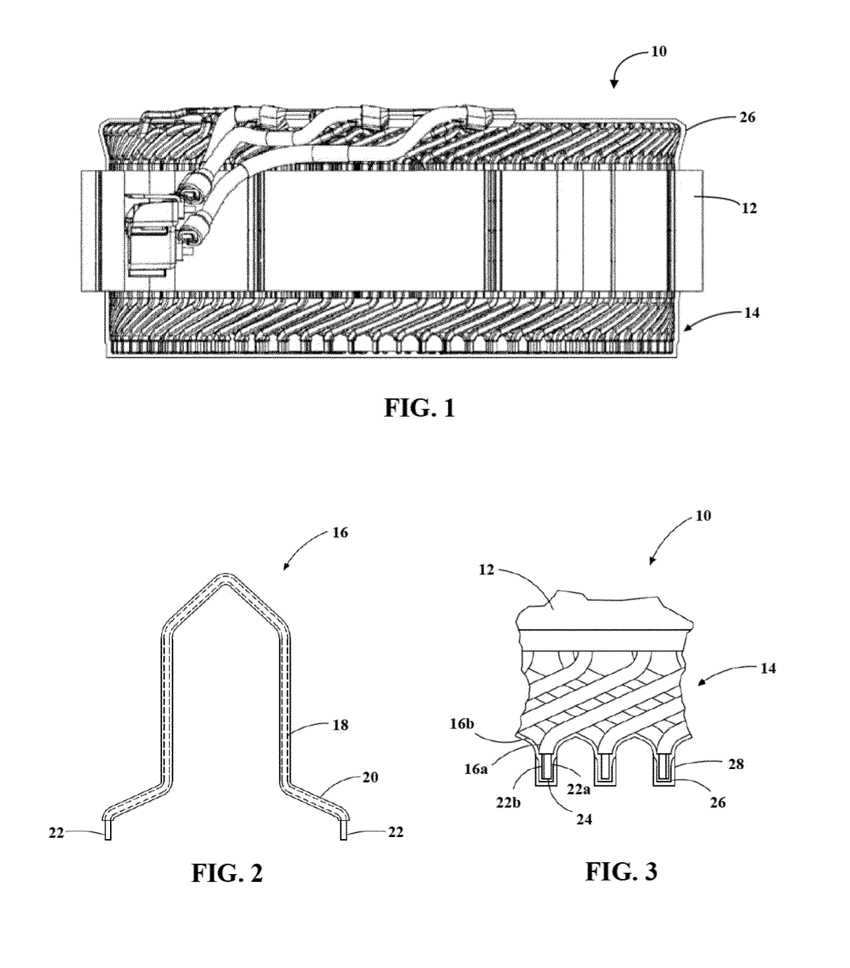

Referring to the drawings, wherein like reference numbers correspond to like or similar components wherever possible throughout the several figures, a stator 10 is shown in FIG. 1. The stator 10 has a stator lamination core 12 that is generally cylindrical in shape. The stator 10 further has a motor winding 14 that is wound around the stator lamination core 12. The motor winding 14 includes a plurality of magnet wires 16, as depicted in FIG. 2.

The stator 10, particularly the motor winding 14, is coated in a first layer 26 of a resin. The resin may be a liquid resin, and serves as a varnish for the stator 10. The first layer 26 may be applied to the stator 10 via a trickling process, as described in method 200 hereinafter.

Referring now to FIG. 2, each magnet wire 16 generally includes a metal wire 18 coated in an insulation layer 20. The metal wire 18 may be, but is not limited to, copper, aluminum, or the like. Each magnet wire 16 further has two distal ends 22 where the insulation layer 20 is stripped, exposing the metal wire 18. The distal ends 22 are configured such that the exposed metal wire 18 at each distal end 22 may be welded to that of a distal end 22 of an adjacent magnet wire 16, as depicted in FIG. 3.

Referring to FIG. 3, adjacent magnet wires 16a and 16b, having distal ends 22a and 22b, respectively, are shown welded together at the distal ends 22a and 22b to form a welded tip 24. Each welded tip 24 is coated in a second layer 28 of the same resin as the first layer 26. The second layer 28 may be applied to the welded tips 24 via a dipping process, also as described in method 200 hereinafter. The second layer 28 generally covers the first layer 26 at the welded tips 24. In another embodiment not shown, the second layer 28 may be applied prior to the first layer 26, as described in method 200 hereinafter, such that the first layer 26 covers the second layer 28.

The second layer 28 serves as a primary insulation for the welded tips 24, and the first layer 26 serves as a secondary insulation for the welded tips 24 in addition to serving as a varnish for the stator 10. As such, the resin should be able to withstand temperatures arising from the current running through the magnet wires 16, which may be dependent upon the specific application of the stator 10. The dual function of the resin as a varnish and as insulation may eliminate the need for separate insulation for the welded tips 24 and varnish for the stator 10. Furthermore, the dual function of the resin may allow the welded tips 24 to be insulated, and the stator 10 to be varnished, at substantially the same time.

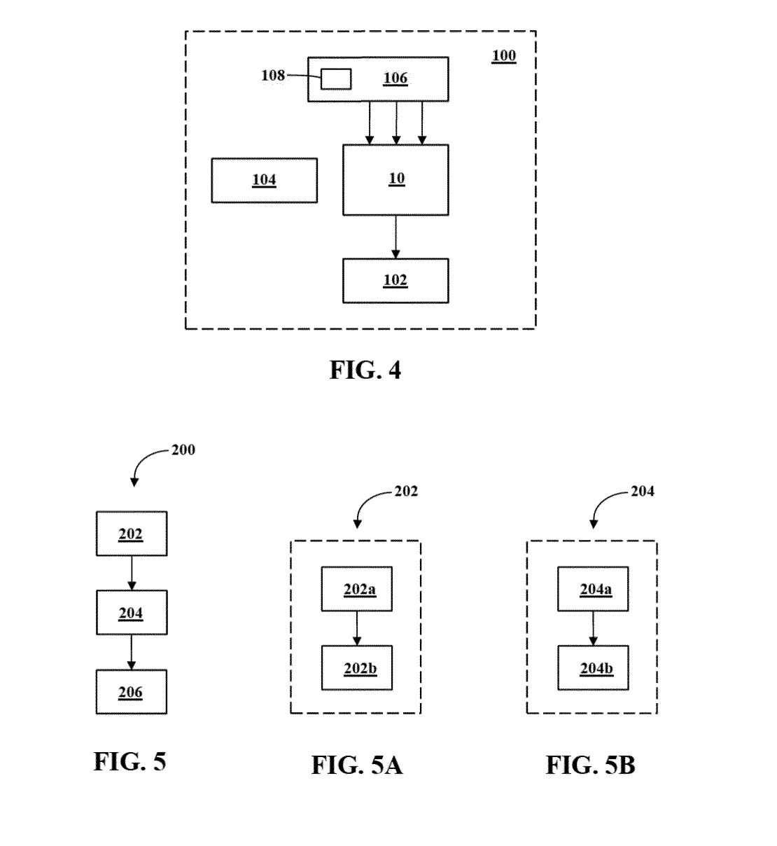

Referring now to FIG. 4, a schematic diagram of a system 100 for applying the resin to the stator 10, and the resin to the welded tips 24, is shown. The system 100 includes a pool 102 of the resin, a first heating source 104, and a trickling device 106. As explained above, the first layer 26 may be applied to the stator 10 via a trickling process. In this process, the resin is trickled over the stator 10 via the trickling device 106 such that the resin may penetrate any nooks or crevices to fully coat the stator lamination core 12 and the motor winding 14. The trickling device 106 may include a second heating source 108 to control the viscosity of the resin, in particular, to make it less viscous, as it is being trickled over the stator 10.

Also as explained above, the second layer 28 may be applied to the welded tips 24 via a dipping process. In this process, the stator 10 is lowered into the pool 102 such that the welded tips 24 are fully coated in the resin. The coated welded tips 24 are then removed from the pool 102, at which point the stator 10 may be baked by the heating source 104 to cure and dry the first layer 26 and the second layer 28.

Referring now to FIG. 5, a method 200 for varnishing the stator 10, and insulating the welded tips 24 of the stator 10 is shown. While method 200 is described with respect to the stator 10 and the system 100, it should be appreciated that method 200 may be applied to any stator using any application system.

Prior to the beginning of method 200, the insulation layer 20 at the distal ends 22 of each magnet wire 16 should be stripped, thereby exposing the metal wire 18. The exposed metal wire 18 at each distal end may then be welded with that of a distal end 22 of an adjacent magnet wire 16, thereby forming welded tips 24.

Method 200 begins at step 202 in which the first layer 26 of the resin is applied to the stator 10 to serve as a varnish. This may include sub-steps, as depicted in FIG. 5A.

Referring to FIG. 5A, at sub-step 202a, the resin is heated by the second heating source 108 to control the viscosity of the resin. At sub-step 202b, the resin is trickled over the stator 10 via the trickling device 106. The trickling will ensure that the resin may penetrate any nooks or crevices to fully coat the stator lamination core 12 and the motor winding 14.

Referring back to FIG. 5, method 200 proceeds to step 204 after step 202. At step 204, the second layer 28 of the resin is applied to the welded tips 24 of the stator 10. Similar to step 202, this may include sub-steps, as depicted in FIG. 5B.

Referring to FIG. 5B, at sub-step 204a, the stator 10 is dipped into the pool 102 of the resin such that the welded tips 24 are fully coated in the resin. At sub-step 202b, the welded tips 24 are removed from the welded pool 102.

Referring back to FIG. 5, method 200 proceeds to step 206 after step 204. At step 206, the stator 10, coated in the first layer 26 of the resin, and the welded tips 24, coated in both the first layer 26 and the second layer 28 of the resin, are cured and dried. This may be done by baking them via the first heating source 104.

Any of the steps of method 200 may be repeated as many times as necessary to provide the desired coating thickness of the first layer 26 and the second layer 28.

It should be appreciated that step 204 may be performed prior to step 202 such that the first layer 26 covers the second layer 28 at the welded tips 28. It should further be appreciated that the first layer 26 and the second layer 28 may be applied via any other process known to a person of ordinary skill in the art.

Prior to step 202, method 200 may further include pre-heating the stator lamination core 12.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A method of insulating welded tips of a stator having a stator lamination core and a motor winding with the welded tips, and varnishing the stator, the method comprising:
applying a first layer of a resin to the stator via a first application process; and
applying a second layer of the resin to the welded tips of the stator via a second application process, the second layer covering the first layer at the welded tips;
wherein the resin serves both as a primary insulation for the welded tips and as a varnish for the stator.

2. The method of claim 1 wherein the second application process may occur prior to the first application process such that the first layer covers the second layer.

3. The method of claim 1 wherein the first application process and the second application process occur at substantially the same time.

4. The method of claim 1 wherein the resin is a liquid resin.

5. The method of claim 1 wherein the first application process comprises trickling the resin over the stator such that the resin coats the stator lamination core and the motor winding.

6. The method of claim 5 further comprising heating the resin to make it less viscous.

7. The method of claim 1 wherein the second application process comprises dipping the welded tips into a pool of the resin such that the welded tips are coated in the resin.

8. The method of claim 7 wherein the first application process further comprises removing the welded tips from the pool of the resin.

9. The method of claim 1 further comprising baking the stator to cure and dry the first layer and the second layer.

10. The method of claim 1 further comprising heating the stator lamination core prior to at least one of applying the first layer of the resin to the stator or applying the second layer of the resin to the welded tips.

11. A system for varnishing a stator having a stator lamination core and a motor winding with welded tips, and insulating the welded tips, the system comprising:
a trickling device to trickle a resin over the stator such that the resin coats the stator lamination core and the motor winding, including the welded tips, to form a first layer of the resin;
a pool of a resin in which the welded tips are dipped to form a second layer of the resin, the second layer covering the first layer; and
a first heating source to bake the stator to cure and dry the first layer and the second layer;
wherein the resin serves both as a primary insulation for the welded tips and as a varnish for the stator.

12. The system of claim 11 wherein the resin is a liquid resin.

13. The system of claim 11 wherein the trickling device comprises a second heating source to heat the resin to make it less viscous.

14. A stator having a common varnish and weld insulation, the stator comprising:
a stator lamination core;
a motor winding wound around the stator lamination core, the motor winding including a plurality of magnet wires substantially parallel to each other, each magnet wire having two distal ends configured such that each of the distal ends is welded to one distal end of an adjacent magnet wire to form a plurality of welded tips;
a first layer of a resin coating the stator, including the welded tips; and
a second layer of the resin coating the welded tips, the second layer covering the first layer at the welded tips;
wherein the resin serves both as a primary insulation for the welded tips and as a varnish for the bar-wound stator.

15. The stator of claim 14 wherein the first layer is covering the second layer.

16. The stator of claim 14 wherein the resin is a liquid resin.

17. The stator of claim 14 wherein the resin is applied to the welded tips via a dipping process.

18. The stator of claim 14 wherein the resin is applied to the stator via a trickling process.
